(19) United States
(12) Patent Application Publication
(10) Pub. No.: US 2012/0262259 A1
(43) Pub. Date: Oct. 18, 2012

(54) LINEAR-ROTARY ELECTROMAGNETIC ACTUATOR

(76) Inventors: Tat Joo Teo, Singapore (SG); Guilin Yang, Singapore (SG)

(21) Appl. No.: 13/502,091

(22) PCT Filed: Oct. 14, 2010
(86) PCT No.: PCT/SG2010/000394

§ 371 Date: Jun. 26, 2012

(30) Foreign Application Priority Data
Oct. 14, 2009 (SG) 200906905-5

(51) Int. Cl. H01F 7/06; H01F 7/02

(52) U.S. Cl. 335/296

(57) ABSTRACT

A linear-rotary electromagnetic actuator with a rotation module having an output shaft and a rotary encoder configured to sense rotary motion of the output shaft; and a translation module having a linear encoder configured to sense translational motion of the intermediate component; and an intermediate translator coupled between the rotation module and the translation module.

### FIELD OF INVENTION

The present invention relates broadly to linear-rotary electromagnetic actuators, and more particularly to linear-rotary electromagnetic actuators suitable for use with feedback control.

### BACKGROUND

Several approaches in the past to provide an actuator capable of both linear and rotary motion have encountered challenges. For example, in high-speed high-precision applications such as pick-and-place, die-bonding, etc, accuracy in the positioning control of the actuating mechanism is critical. For this reason, electromagnetic driving schemes preferably with some feedback control are favoured over pneumatic or hydraulic systems. One electromagnetic approach therefore provides a single rotor with differently oriented magnets arranged in a checkerboard configuration to produce a first magnetic field for linear motion and a second magnetic field for rotary motion. The resulting rotor is unfortunately both difficult and expensive to manufacture. Furthermore, in applications where the range of linear and/or rotary movement is relatively large, as the actuator moves linearly, it is likely to move out of range of the rotary feedback sensor or vice versa. One possible solution is to use multiple linear feedback sensors or multiple rotary feedback sensors, but this again can be expensive.

A need therefore exists to provide a linear-rotary electromagnetic actuator that can address the abovementioned problems.

### SUMMARY

In accordance with a first aspect, there is provided a linear-rotary electromagnetic actuator comprising a rotation module having an output shaft and a rotary encoder configured to sense rotary motion of the output shaft; and a translation module having an intermediate translator coupled to the rotation module and a linear encoder configured to sense translational motion of the intermediate translator.

The rotary encoder may be fixed relative to the intermediate translator.

The rotary encoder may be proximal to the output shaft.

The rotation module may further comprise a Halbach array of permanent magnets arranged to generate a magnetic flux in a single direction in a coil operating region of the Halbach array.

The translation module may further comprise a coil receiving gap between a pair of permanent magnets disposed in an attracting position across the gap.

The translation module may further comprise a first coil arrangement disposed in the coil receiving gap between the pair of permanent magnets, and the rotation module further comprises a second coil arrangement disposed in the coil operating region of the Halbach array of permanent magnets, the intermediate translator being coupled to the second coil arrangement such that the intermediate translator is configured to translate translational motion to the second coil arrangement.

The intermediate translator may further be coupled to the first coil arrangement such that the intermediate translator is configured to translate translational motion of the first coil arrangement to the second coil arrangement.

The linear-rotary electromagnetic actuator may comprise a control scheme configured to provide a first current to the first coil arrangement and a second current to the second coil arrangement, the first current being independent of the second current.

The second coil arrangement may be configured for a single phase, non-commutation control scheme.

The second coil arrangement may be configured for a multi-phase, commutation control scheme.

The translation module and the rotary module may be disposed with an axis of rotation of the rotary module parallel to a linear translation axis of the translation module.

The axis of rotation of the rotary module coincides with the linear translation axis of the translation module.

The linear encoder may be fixed relative to the intermediate translator.

### BRIEF DESCRIPTION OF THE DRAWINGS

FIG. 1: A circular Halbach permanent magnet (PM) array for a rotary actuation according to an example embodiment;

FIG. 2: Numerical analysis result on the magnetic flux flow within the circular Halbach PM array of FIG. 1;

FIGS. 3a and b: Rotation module of a linear-rotary electromagnetic actuator according to an example embodiment;

FIG. 4: Schematic drawing illustrating a two-phase coil configuration for a Halbach rotational module according to an example embodiment.

FIG. 5: High magnetic field Dual-Magnet (DM) configuration according to an example embodiment;

FIG. 6: Analytical results of the magnetic flux density in the DM configuration of FIG. 5 and conventional configurations;

FIG. 7: Numerical analysis result on the magnetic flux flow within the DM configuration of FIG. 6;

FIGS. 8a and: b: Translation module of a linear-rotary electromagnetic actuator according to an example embodiment;

FIG. 9: A 2-DOF (degree-of-freedom) linear-rotary electromagnetic actuator according to an example embodiment.

FIG. 10: A 2-DOF linear-rotary electromagnetic actuator according to another example embodiment.

FIG. 11: A 2-DOF linear-rotary electromagnetic actuator according to another example embodiment.

FIG. 12: A 2-DOF linear-rotary electromagnetic actuator according to another example embodiment.

### DETAILED DESCRIPTION

In one embodiment, a rotary electromagnetic actuator is provided which can achieve a rotational motion of about ±60° with a direct single phase control scheme. An additional set of coil wire, which can be placed 90° out of phase to the coil, increases the rotational range to 360°. In another embodiment, a 2-DOF (degree-of-freedom) linear-rotary electromagnetic actuator is provided. This embodiment employs a Lorentz-force technique and can provide a direct and non-commutation drive while adopting a coil-moving configuration to achieve low moving mass, and high actuating speeds. To deliver independent linear and rotary motion, this actuator mainly includes a translation module and a rotation module.

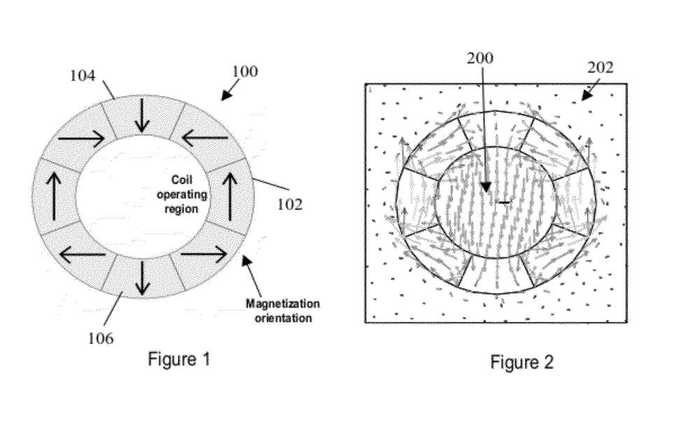

FIG. 1 shows a schematic drawing illustrating a Halbach Permanent Magnet (PM) array 100 employed in a stator of a rotation module in the example embodiment to provide a high magnetic field operating region for a moving-coil rotor. For rotary motion, the Halbach PM array 100 is formed by connecting a series of PM segments e.g. 102 in a circular arrangement. In addition, each PM segment e.g. 102 is pre-magnetized in a specific orientation to preferably ensure that a closed-loop magnetic return flux is formed internally within the PM array 100. Consequently, this arrangement not only concentrates all the magnetic flux density within the coil operating region but also prevents the magnetic flux from leaking to the external surroundings. In the embodiment, eight arc-shaped PM segments e.g. 102 are used to form the circular Halbach PM array 100, which provides magnetic flux flow in one single direction within the coil operating region. The arrangement resembles a Dual-Magnet (DM) configuration (relative to the PM segments 104, 106) except that the closed-loop magnetic return flux is formed by the remaining six arc-shaped PM segments that are magnetized in specific orientations. A numerical simulation in FIG. 2 shows that a high magnetic field can be obtained within the coil operating region 200 through this circular Halbach PM array 202. The vector direction shows that the magnetic flux field flows in one direction, which aids the implementation of the Lorentz-force technique to realize a direct and non-commutation drive angular rotation motion.

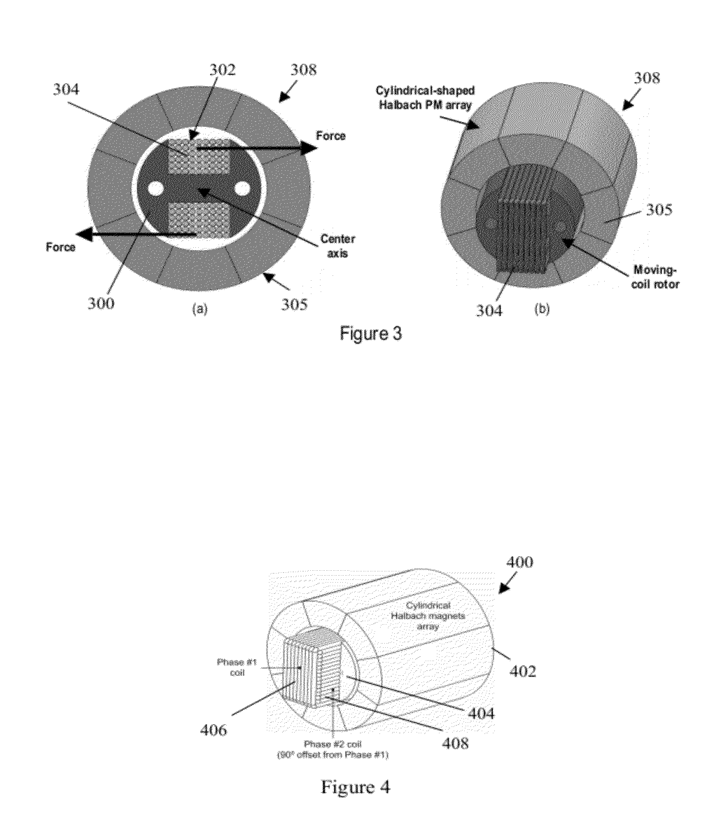

The moving-coil rotor 300 is located at the center of the coil operating region 302, as show in FIGS. 3a and b. The conducting coil wire 304 is wound perpendicular to the magnetic flux flow as shown in FIG. 3a. Two opposite output forces forming a force couple will be generated when the coil 304 is energized and rotates the rotor 300 about its central axis. This working principle in the example embodiment advantageously has a unique feature as compared to conventional rotational electromagnetic driving schemes. For a rotational motion of ±60°, a direct single phase control scheme will be sufficient while the conventional rotational electromagnetic driving schemes require at least two phases of control schemes to generate the same range of motion. In this embodiment, a cylindrical-shaped Halbach PM array 305 is employed in the rotation module 306 and the conducting coil wire 304 will be wound inwards of the Halbach PM array 305 as shown in FIG. 3b.

As will be appreciated by a person skilled in the art, in a single phase, i.e. non-commutation control scheme applied to a single coil is sufficient for rotating the moving coil rotor 300 in ±60° with reference to the magnetic flux direction indicated at numeral 310. That is, in the example embodiment, a dc current is fed into the coil 304, and the polarity of the dc current is changed to change the direction of rotation. It will further be appreciated that practically, controlled rotational movement may be limited to a range of ±(60−Δ)°, since at the ±60° positions, the resulting Lorentz force will substantially be directed radially outward or inward. In example embodiments, Δ≦45°, and more particular Δ=30° may be implemented in one embodiment. To hold the rotor at a particular angular position, the polarity of the coil are constantly regulated through a feedback control via an angular (rotary) encoder.

In another example embodiment, 360° of rotational motion can be achieved through a two-phase commutation control scheme, employing a second coil. For example, FIG. 4 shows a schematic drawing illustrating a two coil configuration for a Halbach rotational module 400 according to an example embodiment. Again, a cylindrical Halbach PM magnets array 402 is provided, for generating a magnetic flux flow in one single direction within the coil operating region. Here, the moving-coil rotor 404 comprises a first coil winding 406, and a second coil winding 408, which is 90° off-set from the first coil winding 406.

In this embodiment, a two-phase control scheme is employed. One or two sources may be used, where the supply of DC current to one coil is lagging with regard to the other coil. For a single DC source scheme, an amplifier with designated A&B phase I/O can be used in one example embodiment. This is a hardware approach where the amplifier has internal circuitry that synchronizes the DC current feeding to both coil simultaneously. For a two-source approach, two amplifiers, where each has a single phase I/O, can be used in another example embodiment, together with an external controller programmed with software for performing synchronization. The DC current feed into the second coil winding will always be lagging the DC current of first coil winding by a fixed time period. This operation, termed “out-of-phase” scheme, ensures that a continuous rotation motion of 360° can be achieved. To hold the rotor at a particular angular position, the polarities of both coils are constantly regulated through a feedback control via an angular (rotary) encoder.

As will be appreciated by a person skilled in the art, this enables control of the total torque applied to the moving coil rotor 404 as a result of the two vectorized force pairs.

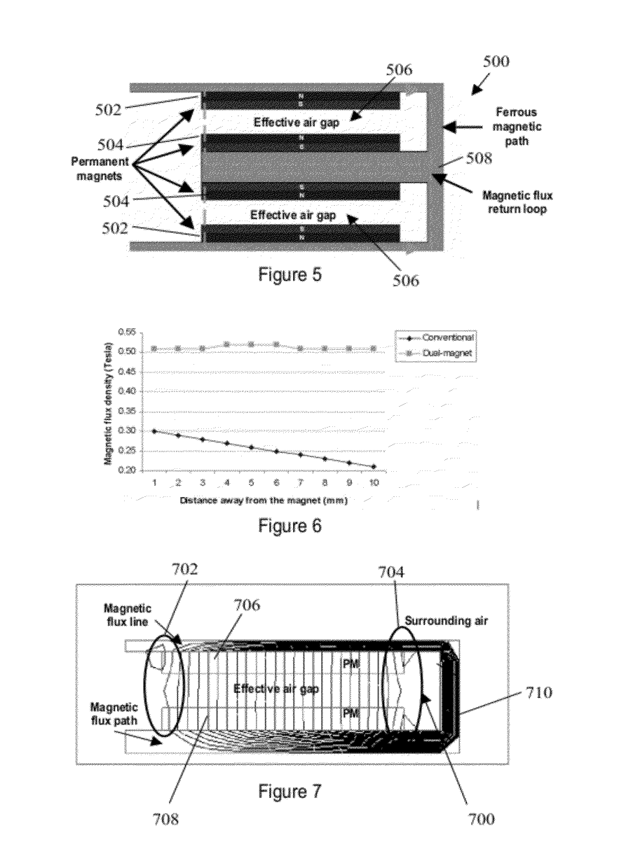

In one embodiment, the rotation module may be integrated with a translation module to form a linear-rotary electromagnetic actuator. FIG. 5 shows a schematic illustrating a DM configuration 500 of a translation module. The DM configuration 500 offers a compact-size design that delivers a large output force. In this embodiment, the DM configuration 500 is formed by placing two permanent magnets 502, 504 (backed by a common magnetic path) facing each other in an attracting position. Hence, the magnetic flux that emanates from the two magnets 502, 504 amalgamates at the mid-section of the air gap 506 and forms a high magnitude and evenly distributed magnetic flux density within the effective air gap 506. Such a configuration also minimizes the common flux leakage at both ends of the magnets 502, 504. The common magnetic path formed from a high permeability material 508 provides a closed-loop return route for the magnetic flux, which further enhances the magnetic flux density throughout the effective air gap 506.

The DM configuration preferably enables the magnetic flux density within the effective air gap 506 to be equal or larger than the residual magnetic density of a Permanent Magnet (PM). In addition, the magnetic flux density is advantageously evenly distributed throughout the effective air gap 506. FIG. 6 plots a graph that compares the magnetic flux density obtained within the height of an effective air gap between a DM configuration and a conventional magnetic configuration, which uses a single PM that has twice the thickness of the PMs used in a DM configuration. From this graph, the analytical results show that a DM configuration offers larger and a more constant magnetic flux density through a 10 mm effective air gap while the magnetic flux density drops linearly for the conventional magnetic configuration.

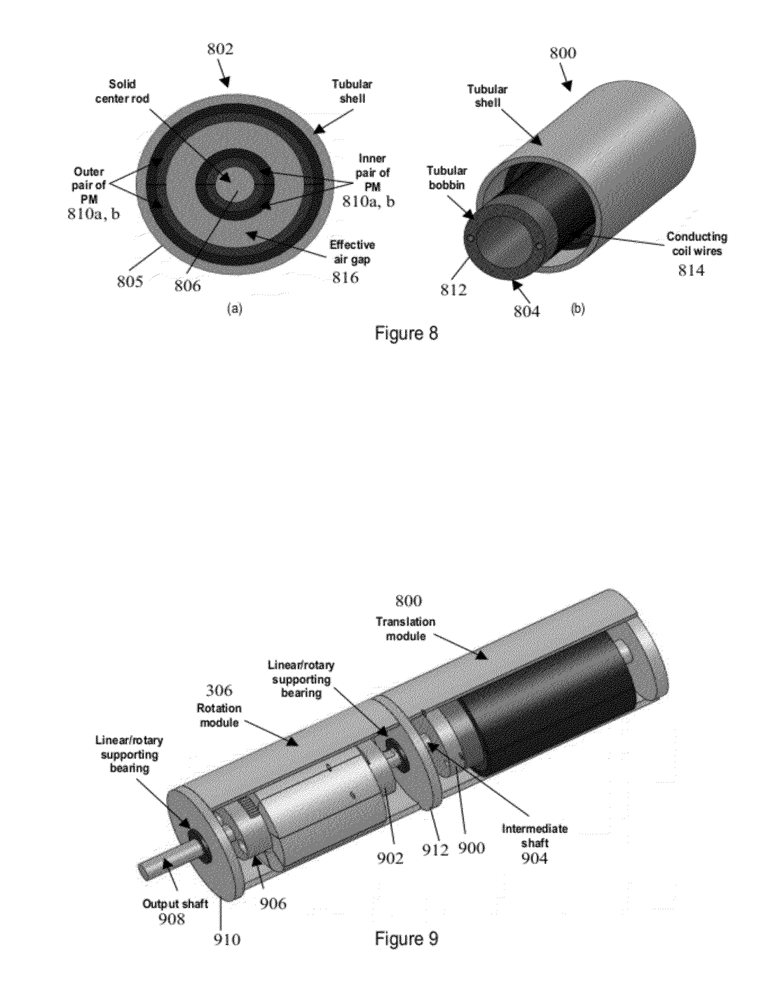

Two-dimensional (2D) magnetic flux flow of a DM configuration was conducted through finite element simulator as shown in FIG. 7. The numerical results suggest that an evenly distributed magnetic flux flows throughout the effective air gap 700. In addition, the results also show that minimal flux leakage at both ends 702, 704 of the PMs 706, 708 is detected and almost no magnetic flux leakage can be found outside the ferrous magnetic flux path 710. In this embodiment, the entire translational module 800 consists of two portions, i.e., a linear stator 802 and a linear translator 804, as shown in FIGS. 8a and b. The linear stator 802 is made up of a tubular iron shell 805, which is connected to a solid rod 806 in the center, and two pairs of radically-magnetized semi-circular tube-shaped PMs 808a, b and 810a, b. The pair 810a b which has a smaller dimension is attached onto the center rod 806 while the other pair 808a, b is attached to the inner wall of the tubular shell 805. This arrangement forms a DM configuration within the tubular shell 805 while the center rod 806 provides the return magnetic path to form a closed-loop path for the magnetic flux to flow within this configuration as shown in FIG. 8b. On the other hand, the linear translator 804, which is a non-ferrous tubular bobbin 812, only carries a moving air-coil 814 and provides a mechanical translation motion when the coil 814 is energized. This linear translator 804 is placed in between the two pairs 808a, b and 810a, b of PMs and this arrangement allows the wound coil 814 to operate within the effective air gap 816 of the DM configuration as shown in FIG. 8b.

The linear-rotary electromagnetic actuator according to the example embodiment is formed by integrating the translation module 800 with the rotation module 306 as illustrated in FIG. 9. The moving-coil linear translator 900 of the translation module 800 is connected to the moving-coil rotor 902 of the rotation module 306 via an intermediate shaft or intermediate translator 904 while the front portion 906 of the moving-coil rotor 902 is connected to an output shaft 908. The output and intermediate components or shafts 908, 904 are supported by bearings 910, 912 respectively that allow the shafts to move in linear and rotary motions. Consequently, the moving-coil translator 900 provides the independent linear motion and the moving-coil rotor 902 provides the independent rotational motion.

Accordingly, translational movement of the moving-coil linear translator of the translation module 800 is transferred to the (output) component or shaft 908, and independently the shaft 908 is rotatable under the control of the rotation module 306. In this embodiment, a rotary encoder (not shown) may be provided at the output shaft 908 where the rotary encoder would be advantageously capable of sensing the rotational motion of the output shaft 908 for the full range of rotational motion. The full range of rotational motion may advantageously be as much as 360°, depending on the desired application as it is no longer constrained by cost and other physical limitations to a smaller range of rotational motion. A linear encoder (not shown) may be provided at the intermediate translator 904 or between the rotation module 306 and translation module 800 such that it is advantageously capable of sensing the translational position of the intermediate translator 904 that is driven only by the translation module 800 for the full range of translational motion. Advantageously, only one linear encoder is required for the full range of translational motion. As will be appreciated by a person skilled in the art, the rotary encoder and the linear encoder in effect sense the rotational and translational position respectively of the output shaft 908 for feedback to a control circuit (not shown).

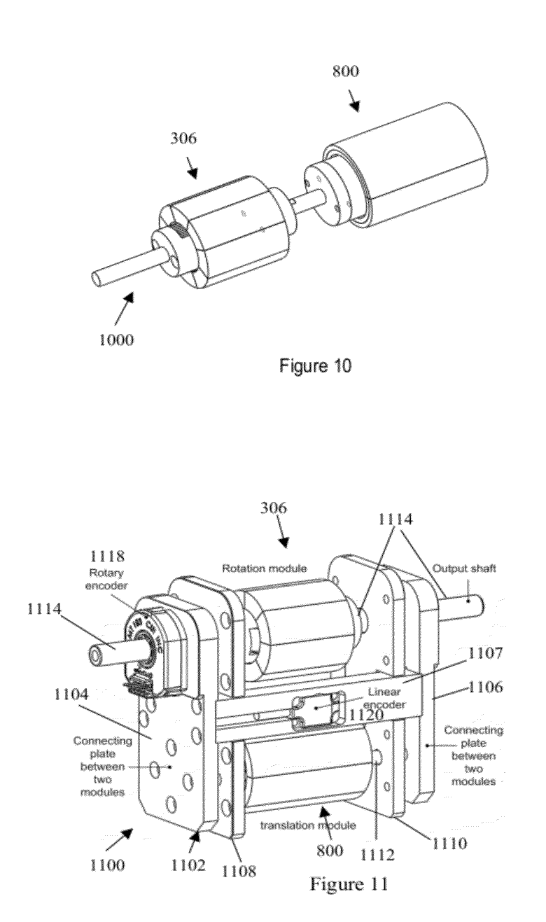

It will be appreciated that in a different embodiment, a linear-rotary electromagnetic actuator 1000 may be formed by similarly integrating the translation module 800 with the rotation module 306, but without internal supporting bearings, as illustrated in FIG. 10. Such a linear-rotary electromagnetic actuator 1000 can be employed utilizing external bearing structures (not shown) associated with a particular application environment/structure. Similarly, this embodiment of a linear-rotary actuator advantageously provides for a rotary encoder to be located at the output end of the rotation module 308 and a linear encoder to be located between the translation module 800 and rotation module 308.

The moving-coil configuration in the example embodiments can provide high-speed actuation due to the low moving mass of the rotor and the translator. Both moving-coil translator and rotor are connected together to simplify the entire moving component and are ironless to eliminate hysteresis and clogging effects. The Lorentz-force actuation technique allows the actuator to provide a direct single-phase non-commutation control for ±60° and a linear current-force relationship. The Halbach PM array and DM configuration can enhance the output torque and the output thrust force of the actuator respectively.

FIG. 11 shows an alternative linear-rotary electromagnetic actuator 1100 according to another example embodiment. Again, the linear-rotary electronic electromagnetic actuator is formed by integrating the translation module 800 with the rotation module 306, however here in a parallel/dual-axes configuration. More particular, the translation module 800 and the rotation module 306 are coupled to each other using a connecting frame structure, generally indicated at 1102. The frame structure 1102 comprises two moveable connecting plates 1104, 1106 with a pair of connecting beams 1107 (the other beam is hidden in FIG. 11) connected between the connecting plates 1102, 1104. In turn, the beams e.g. 1107 are supported and guided by base brackets 1108, 1110. the base brackets 1208; 1210 carry and are fixed relative to the non-moving parts of the translation module 800 and the rotation module 306 The connecting plate 1106 is fixedly connected to one or more shafts 1112 connected to the moving-coil linear translator of the translation module 800. On the other hand, the connecting plates 1104, 1106 are connected to a shaft 1114 connected to the moving-coil rotor of the rotation module 306 in a manner such that the shaft 1114 is free to rotate relative to the connecting plates 1104, 1106, while the translational position of the shaft 1114 relative to the connecting plates 1104 and 1106 is fixed. In one example embodiment, the connection between each of the connecting plates 1104, 1106 and the shaft 1114 is by way of a bearing which provides a single (rotational) DOF such as the rotary ball-based bearings etc.

Accordingly, translational movement of the moving-coil of the translation module 800 is transferred to the (output) shaft 1114 by components collectively referred to here as the intermediate translator, and independently the output shaft 1114 is rotatable under the control of the rotation module 306. In this embodiment, a rotary encoder 1118 is provided fixed relative to, and in this embodiment mounted on, the intermediate translator (more particular on the connecting plate 1204) at the output component or shaft 1114 where the rotary encoder 1118 is advantageously capable of sensing the rotational motion of the output shaft 1114 for the full range of rotational motion. The full range of rotational motion may advantageously be as much as 360°, depending on the desired application as it is no longer constrained by cost and other physical limitations to a smaller range of rotational motion. A linear encoder 1120 is provided fixed relative to, and in this embodiment mounted on, the intermediate translator (more particular on the connecting beam 1107) such that it is advantageously capable of sensing the translational position of the intermediate translator (and thus the output shaft 1114) that is driven only by the translation module 800 for the full range of translational motion. Advantageously, only one linear encoder is required for the full range of translational motion. As will be appreciated by a person skilled in the art, the rotary encoder 1118 and the linear encoder 1120 in effect sense the rotational and translational positions respectively of the output shaft 1114 for feedback to the control circuit (not shown). Advantageously, the control circuit may drive the rotation module 306 and the translation module 800 by providing a current to the moving coil of the rotation module independent of a current provided to the moving coil of the translation module.

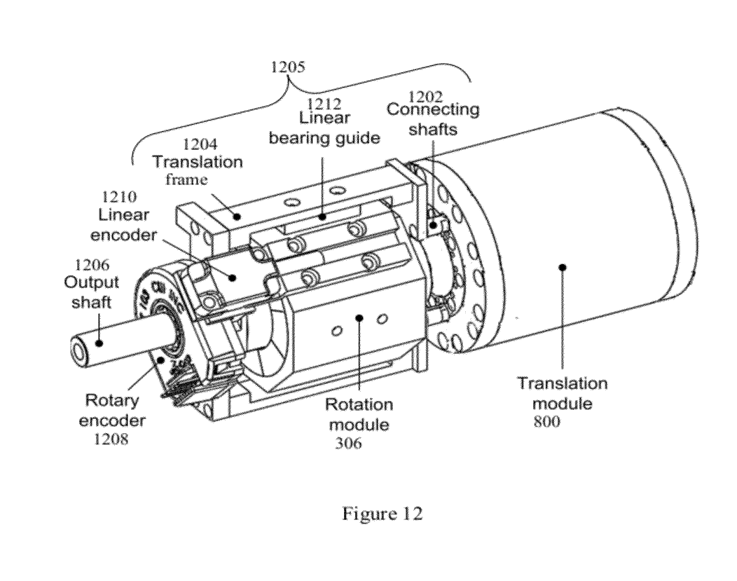

Another example embodiment of a linear-rotary electromagnetic actuator 1200 is shown in FIG. 12. In this configuration, the translation module 800 is located substantially co-axially with the rotation module 306. Connecting shafts e.g. 1202 are used to connect the moving coil of the translation module 800 to a translation frame 1204 that extends to and is coupled to the moving coil of the rotation module 306. The connecting shafts e.g. 1202 and translation frame 1204 may be collectively described as an intermediate translator 1205, which undergoes translational or linear motion when the translation module 800 is operated. This translational motion is accordingly provided to the moving coil of the rotation module 306 and independent to the rotational motion provided by the rotation module 306. The resultant motion of the output shaft 1206 is therefore a combination of translational motion imparted by the translation module 800 and rotational motion imparted by the rotation module 306. A rotary encoder 1208 for sensing the rotational motion may advantageously be fixed relative to, and in this embodiment mounted on, the intermediate translator 1205 proximal to the output shaft 1206. In this manner, any translational motion of the output shaft 1206 will not bring the output shaft 1206 out of the detection or operational range of the rotary encoder 1208. Placement of a single rotary encoder 1208 proximal to the output shaft provides accurate feedback on angular displacement of the output shaft 1206 to a control circuit (not shown) for the whole range of movement possible with the linear-rotary electromagnetic actuator 1200. A linear encoder 1210 for sensing the translational or linear motion may advantageously be fixed relative to, and in this embodiment mounted on the intermediate translator 1205, and at a portion thereof that is closest to the output shaft 1206. This arrangement advantageously provides accurate feedback on translational or linear displacement of the intermediate translator 1205 (which would be equivalent to the linear displacement of the output shaft 1206) to the control circuit. In this manner, one single linear encoder 1210 may serve for the full range of motion regardless of the rotational motion of the linear-rotary electromagnetic actuator 1200. In addition, the intermediate translator 1205 may advantageously have a linear bearing guide 1212 mounted thereon for sliding engagement or bearing engagement with a corresponding guide member (not shown) coupled to an external surface of a non-rotating part of the rotation module 306. This arrangement increases the stiffness in the non-actuating directions of the linear-rotary electromagnetic actuator 1200.

Example embodiments of the rotation module of the present invention can offer a robust configuration for 360° of rotational motion using a direct two-phase commutation control scheme together with an additional coil, which is placed at 90° out of phase to a first coil of the rotor. Furthermore, three coils at 60° out of phase with a direct three-phase commutation control scheme can also be employed to enhance the torque and accuracy of the rotational motion.

The DM configuration in the translation module allows the implementation of a Lorentz-force technique to achieve a linear and direct translational motion. A moving-coil configuration is employed in both the translation and the rotation modules to provide a low moving-mass, non-hysteresis and clog-less motion in a linear-rotary electromagnetic actuator according to present embodiments. However, similar motions can also be realized through a moving-magnet approach by fixing the coil-wound translator and rotor while the permanent-magnet stators become free-moving.

The multi-coil arrangement in the example embodiments allows one independent control scheme to be implemented on each module. Thus, the rotation module (rotational motion) and the translation module (translational motion) may be controlled independently of each other.

Applications of embodiments of the linear-rotary magnetic actuator include in high-speed and high-precision parts handling (pick-and-place) and assembly, e.g.: pick-and-place tool heads for PCB assembly (as in Surface-Mounting Technology); 3D integrated circuit chip assembly; wafer sorting; die attaching; electronic packaging; optoelectric assembly, etc.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. For example, various control circuits known to a person skilled in the art may be used in conjunction with the linear-rotary electromagnetic actuators described in the foregoing.

1. A linear-rotary electromagnetic actuator comprising:
a rotation module having an output shaft and a rotary encoder configured to sense rotary motion of the output shaft; and
a translation module having an intermediate translator coupled to the rotation module such that a translational movement of the intermediate translator is provided to a moving coil relative to a fixed magnet of the rotation module or to a moving magnet relative to a fixed coil of the rotation module and a linear encoder configured to sense translational motion of the intermediate translator.

2. The linear-rotary electromagnetic actuator of claim 1 in which the rotary encoder is fixed relative to the intermediate translator.

3. The linear-rotary electromagnetic actuator of claim 2 in which the rotary encoder is proximal to the output shaft.

4. The linear-rotary electromagnetic actuator of claim 1 in which the rotation module further comprises a Halbach array of permanent magnets arranged to generate a magnetic flux in a single direction in a coil operating region of the Halbach array.

5. The linear-rotary electromagnetic actuator of claim 4 in which the translation module further comprises a coil receiving gap between a pair of permanent magnets disposed in an attracting position across the gap.

6. The linear-rotary electromagnetic actuator of claim 5 in which the translation module further comprises a first coil arrangement disposed in the coil receiving gap between the pair of permanent magnets, and the rotation module further comprises a second coil arrangement disposed in the coil operating region of the Halbach array of permanent magnets, the intermediate translator being coupled to the second coil arrangement such that the intermediate translator is configured to translate translational motion to the second coil arrangement.

7. The linear-rotary electromagnetic actuator of claim 6 in which the intermediate translator is further coupled to the first coil arrangement such that the intermediate translator is configured to translate translational motion of the first coil arrangement to the second coil arrangement.

8. The linear-rotary electromagnetic actuator of claim 6 further comprising a control scheme configured to provide a first current to the first coil arrangement and a second current to the second coil arrangement, the first current being independent of the second current.

9. The linear-rotary electromagnetic actuator of claim 6 in which the second coil arrangement is configured for a single phase, non-commutation control scheme.

10. The linear-rotary electromagnetic actuator of claim 6 in which the second coil arrangement is configured for a multi-phase, commutation control scheme.

11. The linear-rotary electromagnetic actuator of claim 1 in which the translation module and the rotary module are disposed with an axis of rotation of the rotary module parallel to a linear translation axis of the translation module.

12. The linear-rotary electromagnetic actuator of claim 11 in which the axis of rotation of the rotary module coincides with the linear translation axis of the translation module.

13. The linear-rotary electromagnetic actuator of claim 1 in which the linear encoder is fixed relative to the intermediate translator.
